(19) United States
(12) Patent Application Publication
(10) Pub. No.: US 2007/0111188 A1
(43) Pub. Date: May 17, 2007

(54) Reference card creation system and method

(76) Inventor: Timothy A. Shell, Houston, TX (US)

Correspondence Address: STRASBURGER & PRICE, LLP, 901 MAIN STREET, SUITE 4400, DALLAS, TX, 75202, US

(21) Appl. No.: 11/601,244

(22) Filed: Nov. 17, 2006

Related U.S. Application Data
(60) Provisional application No. 60/737,491, filed on Nov. 17, 2005.
(60) Provisional application No. 60/748,654, filed on Dec. 8, 2005.
(60) Provisional application No. 60/784,662, filed on Mar. 22, 2006.

(51) Int. Cl. G09B 3/00

(52) U.S. Cl. 434/350

(57) ABSTRACT

A system and method for enhancing learning or recollection by the use of custom reference cards including learning objects extracted from a content database. The learning objects may be either pre-written or created by users.

### CROSS REFERENCE TO RELATED APPLICATIONS

This Non-Provisional U.S. Patent application claims the benefit of Provisional U.S. Patent Applications 60/737,491 filed Nov. 17, 2005; 60/748,654 filed Dec. 8, 2005 and 60/784,662 filed Mar. 22, 2006

### STATEMENT REGARDING FEDERALLY FUNDED RESEARCH AND DEVELOPMENT

The invention described in this patent application was not the subject of federally sponsored research or development.

### FIELD

The present invention pertains to a software enabled learning enhancement system; more particularly, the present invention pertains to a computerized system for creating and providing quick access to user-customized reference cards containing short reminders of needed information to perform a defined task or exhibit a predetermined behavior.

### BACKGROUND

The following description of the background for the instant invention is written primarily in terms of its applicability to use with software; however it will be understood that the applicability of the present information pertains to any activity which requires the recall of information which is either not easily recalled to the level of detail needed, in the format desired, or pertains to information which is used on an infrequent basis.

Since computers have become a fixture on the desks of many in recent years, it has become necessary for regular computer users to learn how to navigate through and operate the various different pieces of software loaded on both the individual computers being used as well as the multiple software programs accessible through the networks to which the individual computers may be attached.

Typically, when a business launches the use of a new software program, computer users are first given a class to familiarize them with how the new software program operates and then how to use the new computer program. Once the class is over, one-on-one trainers may be made available to the computer users for short periods of individual instruction to assist the computer users when they have particular problems getting started or navigating their way through the more difficult portions of the software program. After the one-on-one trainers leave and individual instruction is no longer available, the computers users are essentially left on their own.

Problems navigating through software programs typically occur when computer users do not make regular use of a software program. Specifically, computer users forget what they have learned or become confused when using a piece of software because the software program or certain specialized aspects of the software program are not used on a regular basis. Some ambitious computer users keep reference books describing the various pieces of software accessible by their computer near their work station. These reference books are used to provide a memory refresher about how a software program operates and how the various functionalities offered by a software program are used. Unfortunately, many of these reference books are difficult to read and provide far too much information concerning the operation of individual functionalities offered by a software program. Accordingly, some publishers have distilled the information available about certain software programs into shortened statements on reference cards which are furnished along with software program reference books. Other publishers have assembled software program reference cards into book form. These books of reference cards may generally be found alongside the manuals which describe the operation of a software program in great detail on a computer user's bookshelf. For a few computer users the reference cards provide an invaluable tool. For most computer users the commercially available reference cards are either too generic or too detailed to provide any significant value.

Another problem with books of reference cards providing help in operating a software program is that most computer users do not need all of the reference cards contained in the book of reference cards; rather, most computer users need only those few reference cards which describe the operation of those portions of a software program most frequently used. But, because one must buy a whole book of reference cards, some computer users turn to just a few of the reference cards on a regular basis and the remainder of the reference cards are left unused.

Yet another problem is that many computer users carry their computers away from both their work stations and away from their library of software manuals and reference cards. When the computer is set up again by a user for operation, the user finds himself/herself in a situation where there is a need for a reminder on how to navigate through a certain portion of a software program. But, no reminders are available because the computer user is away from the manuals and reference cards at the user's work station. Some users try to use the “Help” feature associated with many software programs, but find the instructions contained therein to be too general to be effective. Other users rely on a call-in “Help Desk” service provided by either their employer or the maker of the software program; but are dismayed to discover that the Help Desk is not manned with competent personnel just when they are having a problem navigating their way through a software program.

Still another problem with pre-printed reference cards is that they may be satisfactory for the author—typically a software expert—but completely worthless to a user who does not think like a software expert. The reason for this is well known by anyone who has been involved in teaching or training—different people need different reminders expressed in different ways as well as different bits of information to accomplish a task.

And yet another problem with pre-printed reference cards is that they ignore the idea that people learn in different ways. While text reminders may be adequate for some users, others users need more visual reminders such as actual screen shots as opposed to a textual description of what keys to press or buttons to be clicked on.

Accordingly, there remains a need in the art for a system which will enable the user of a software program to gain quick access to only those reference cards needed which pertain to those aspects of operating a software program which the computer user either does not remember or which the computer user is unfamiliar with because of lack of use. Further, there remains a need in the art for a computer user to create a reference card customized to his/her learning style and containing the information needed to enable the completion of a task.

As previously indicated, those of ordinary skill in the art will also understand that the disclosed invention, while described in terms of its use with the operation of software programs has applicability to a broad range of other subject matter where a user must become an expert in a short period of time. For example, a businessman such as a salesman may be asked to meet with a potential customer to explain the features and advantages of a product or a service that the salesman does not fully recall where the product or service has not been demonstrated to a customer in several years. By gaining access to a reference card describing the product or service to be demonstrated, the salesman will be able to refresh his/her memory about the features and advantages of a product or service or learn about enough features describing a product or service to answer the questions of a potential customer.

In another situation, a reference card may be needed to assist a user with installing a replacement item such as a faucet which is generally not provided to a user with a set of instructions.

In still another situation, a user may be involved in a project which takes place over an extended period of time such as the disassembly and re-assembly of a motor taken from a vehicle being restored. In such cases, it is not unusual for many months to pass between disassembly and re-assembly. During this extended time period it is not unusual for an automobile hobbyist to lose recall about how some of the parts of a motor fit back together.

### SUMMARY

According to the system and method of the present invention, users are provided the ability to rapidly design and develop training, sales and subject matter expert materials. The materials designed and developed according to the disclosed invention are in the form of user-customized reference cards which can be produced in hard copy, video or sound images. By further use of a content development tool, users can develop learning objects and place the learning objects on the reference cards in a format suitable to the user's individual preference. Further, according to the system and method of the present invention, content for the reference cards can be developed from either publicly available information, custom developed learning objects or both.

Users of the system and method of the present invention begin by embedding learning objects into a content database. Custom format layouts for the reference cards are then embedded into a style database. A survey tool is then utilized to identify the needs of the users of the system and method of the present invention. The content database corresponds to the survey tool to allow the creator of the reference cards to map or match the needs identified by the survey tool the learning object in the content database. Once mapped, the learning objects needed are taken by a selector tool from the content database. With the learning object selected and removed from the content database, the user then selects a style formatting tool which best suits the needs and learning style of the user. If needed, titles and subtitles are submitted. With all of this information, the system and method of the present invention produces a reference card suitable for reproduction in any format which best serves the needs of the user.

### BRIEF DESCRIPTION OF THE DRAWING FIGURES

A still better understanding of the system and method of the present invention may be had by reference to the drawing figures wherein:

FIG. 1 is a screen shot beginning the creation of a set of one or more learning objects associated with a topic;

FIG. 2 is a screen shot of what appears after clicking on the Create button in FIG. 1;

FIG. 3 is a screen shot of what appears after clicking on the Approve button in FIG. 1;

FIG. 4 is a screen shot of what appears after clicking on the Add Title button in FIG. 1;

FIG. 5 is a screen shot of what appears after clicking on the Manage button in FIG. 1;

FIG. 6 is a flow chart depicting an overview of a user's experience with the system and method of the present invention;

FIG. 7 is a screen shot of the first screen greeting a user;

FIG. 8 is a screen shot of the Home page;

FIG. 9 is a screen shot of the Titles page;

FIG. 10 is a screen shot of the Topics page;

FIG. 11 is a screen shot of the Search page;

FIG. 12 is a screen shot of the Layout page;

FIG. 13 is a screen shot of the Layout data page;

FIG. 14A is a first sample of a reference card;

FIG. 14B is a second sample of a reference card;

FIG. 14C is a third sample of a reference card.

### DESCRIPTION OF THE EMBODIMENTS

A still better understanding of the present invention may be had by a brief review of the learning process typically used to instruct a human being about how to perform a defined task or exhibit a predetermined behavior. In the education and training model experienced by most Americans, the information that is to be imparted to a human being for the purpose of performing a defined task or exhibiting a predetermined behavior is typically organized into an outline fashion; that is, the information to be learned is broken down into groups and sub-groups. The use of groups and subgroups facilitates both understanding and retention for most learners. The groups and sub-groups of information are then connected together by the design of the instructional program to build on one another to enable the completion of more complex tasks. For example, basic arithmetic is taught by teaching children how to add and subtract numbers in problems of increasing size and complexity. Once addition and subtraction skills have been mastered the related, but more difficult, concepts of multiplication and division are then added to the learning process.

From the instructor's perspective, the learning process begins and is organized by identifying goals to be attained during a course of instruction. In schools and universities, the goals to be attained are then broken down into class-size increments over a quarter, a semester or an academic year. In each class-size increment, an instructor will establish a set of learning objectives to be attained. The learning objectives will be like a set of skills which build, one upon another, to enable the performance of the larger and more complex skills which are to be material upon completion of the course of instruction.

The art and skill of the instructor is to communicate to the students, according to the way students learn the material being presented, the information needed to cause an understanding and a mastery of the learning objectives associated with a course of instruction. It is here where the classroom model of an instructor teaching multiple students begins to break down. This breakdown occurs because people learn in different ways, be it visual, audio, or kinesthetic, and people learn at different rates. In addition, instructors generally teach according to their own learning method. Thus, if a kinesthetic learner is being taught by a visual learning instructor, communication and retention of information will be slower and much more difficult for the student. To meet the needs of the kinesthetic learner, an instructor will need to slow down and oftentimes repeat the material to be learned in several different ways to enable an understanding and retention of the material by the kinesthetic learner. In the meantime, the visual learners receiving instruction from a visual learning instructor will have picked up the needed information very quickly and will lose interest in learning while the instructor repeats the material for the kinesthetic learner. The end result is that most classroom instructors design a class not for the brightest and fastest learners, but instead for those learners who do not pick up the material being taught as quickly.

The problem of a mismatch between the teaching skills of an instructor and the learning skills of a student is sometimes solved by the proper selection of a personal tutor who has a mastery of the material needed to be taught and has a teaching ability which matches the learning abilities of a particular student. Unfortunately, despite the efforts of educators at all levels, mismatches between the teaching styles of instructors and the learning styles of students remain. It is here where the advent of computerized learning methods have made major improvements in overcoming instructor-student mismatches in the learning process. By the use of properly crafted software programs students who are visual, audio or kinesthetically learners can be reached by visually oriented, audio oriented or kinesthetic oriented software programs.

It is the job of the student to retain the information conveyed by an instructor which results in an understanding and a mastery of the learning objectives established by the instructor and to use that material at a later time to demonstrate a mastery of the learning objective to perform a task or solve a problem with the learned material.

Performing a task or solving a problem requires the linking together of three things: a) an understanding of the words and phrases used to describe the concepts within the learned material; b) a memory of the techniques or steps needed to perform a defined task or exhibit a predetermined behavior; and c) a mastery of whatever is needed to actually apply the techniques or steps needed to perform a defined task or exhibit a predetermined behavior.

The weakest link for most human beings is the memory of the techniques or steps needed to perform a defined task or exhibit a predetermined behavior. It is also the case for most people that the once the memory is refreshed about the techniques or steps needed to perform a defined task or exhibit a predetermined behavior the meaning of the words and phrases used to describe the concepts within the learned material and the ability to perform the defined task or exhibit a predetermined behavior return. Thus, if a human being is provided with a refresher of the needed information, an understanding of the terminology and the abilities to perform the defined task or exhibit a predetermined behavior returns.

The problem for many, however, is that the memories of people work differently. The memories of some people are refreshed by words, some by pictures, some by symbols or still others by descriptions of physical activity. Thus what works to refresh the memory of one person may not work to refresh the memory of another person. Accordingly, whatever is needed to refresh one's memory is highly personalized. The solution to this problem is to enable the creation of memory refreshers for individuals using content taken from pre-written learning objectives or from learning objectives formulated by the person whose memory is to be refreshed.

The first important aspect of the system and method of the present invention is the creation of a body of content described herein as learning objects associated with a topic. This body of learning objects may be contained in a content database formed from publicly available information or from information selected by the user or information selected by another, e.g. the user's employer. The learning objects are reusable; that is, they may be used as frequently as needed and the subject matter is current.

The process of creating content for a reference card matches that used in large training management systems such as in the military. The process begins by determining the needs of those receiving the memory reminders provided by the reference cards. Such information can be gathered by the use of surveys or interviews. The information needed is then distilled into learning objects or training goals. These training goals are further distilled into certain knowledge, skills, or tasks which must be mastered to accomplish a training goal.

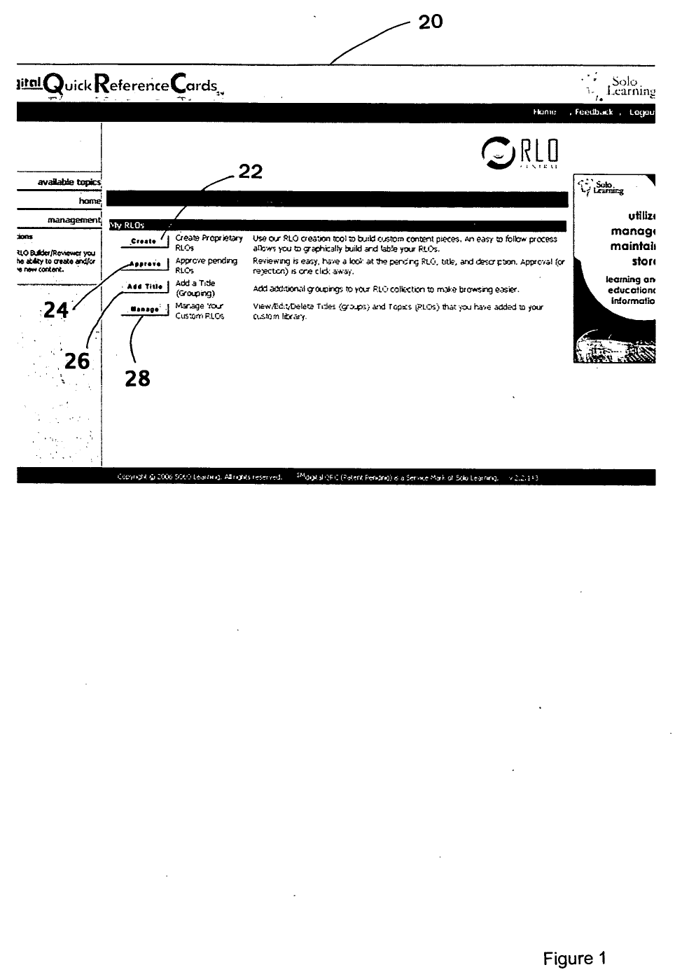

The process of creating learning objects is displayed in FIG. 1 through FIG. 5. The initial screen 20 for the creation of learning objects appears at FIG. 1. The user is presented with a series of selected functionalities represented by “CREATE”, “APPROVE”, “ADD TITLE” and “MANAGE” buttons. The CREATE button 22 enables the building of pieces of custom content. The APPROVE button 24 enables acceptance of the custom content once created. The ADD TITLE button 26 enables grouping of the learning objects to facilitate browsing. The MANAGE button 28 allows for the viewing, editing or deleting of Titles and learning objects, called Titles. For the purpose of the following discussion, a Title is a subset of a Library and a Topic is a subset of a Title.

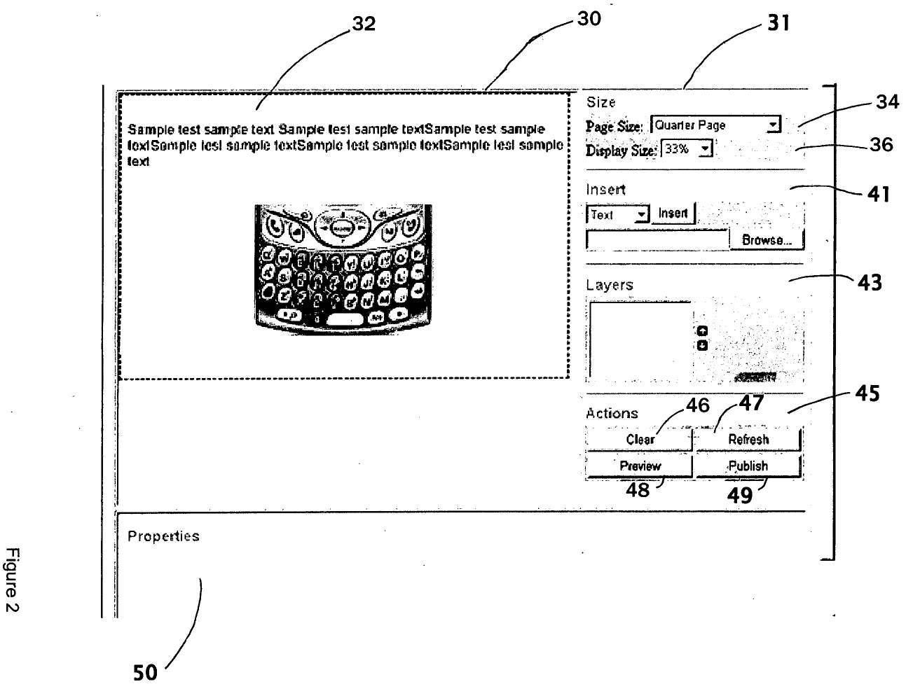

Use of the CREATE button 22 is shown in FIG. 2. In the upper left corner of the screen 30 appears a preview window 32 for showing builders of one or more learning objects to view what has been created. In the upper right hand corner of the screen is a section 31 for size control beginning with a page size selection box 34 presenting options of a quarter page, half page vertical, half page horizontal, and full page. Under the page size selection box 34 is a display size selector box 36 which allows users to zoom in or zoom out while building a learning object.

Under the size block 31 is an insert block 41 which allows for constructing the learning object. Available options include text, image (used with the browse button), square, triangle, circle, and arrow.

Under the insert block is a layers box 43 which allows builder of learning object content to determine, by object, the order in which the content is stacked on the page.

Under the layers box is an actions box 45 which includes four buttons CLEAR, REFRESH, PREVIEW and PUBLISH. The CLEAR button 46 is used to eliminate all learning objects from the preview window in the upper left hand corner. The REFRESH button 47 updates the saved, but not seen, working copy of the learning objects. The PREVIEW button 48 displays the working copy of the learning objects. And, the PUBLISH button 49 saves the working copy of the learning objects, closes out use of the screen and takes the user to the next step in the learning object creation process—naming the learning object and adding a text description.

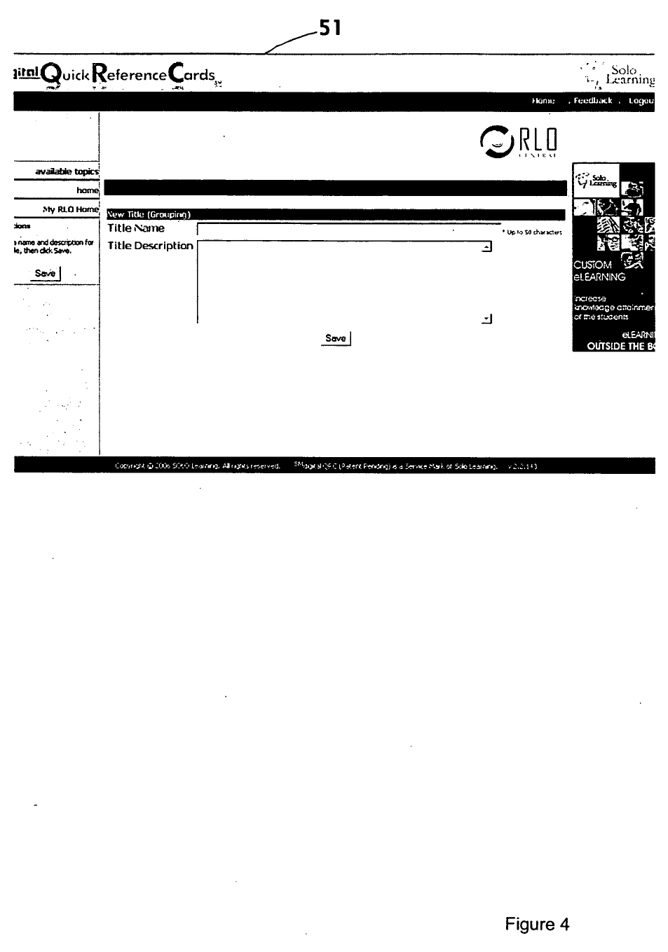

At the bottom of the screen is a properties window 50 in which editable properties appear for the various objects. As shown in FIG. 2, the properties window 50 may include a learning object list which allows the creator to select or delete distinct learning objects. In addition, the creator is prompted to enter a name for each learning object. Further, color options may be selected as well as shape objects to display the newly created learning object. If an arrow is selected it may be oriented and sized. Further the properties window enables selecting font size and type to include a font style such as bold italics or underlines and the color of the font and the color of the border. The naming and review process of the learning object complete the sequence of building learning object content associated with a particular Topic. As shown by the screen 51 in FIG. 4, after a learning object has been built, the creator provides a Topic Name, a Topic Description places the Topic within a Title group.

Once the learning object has been named, the creator must review the work done and send it to a pending file for later review if approval by someone with approval authority is required. Once the work has been sent to a pending file, the creator is informed that the learning object is subject to review by someone with the necessary credentials to either approve or reject the content of the learning object.

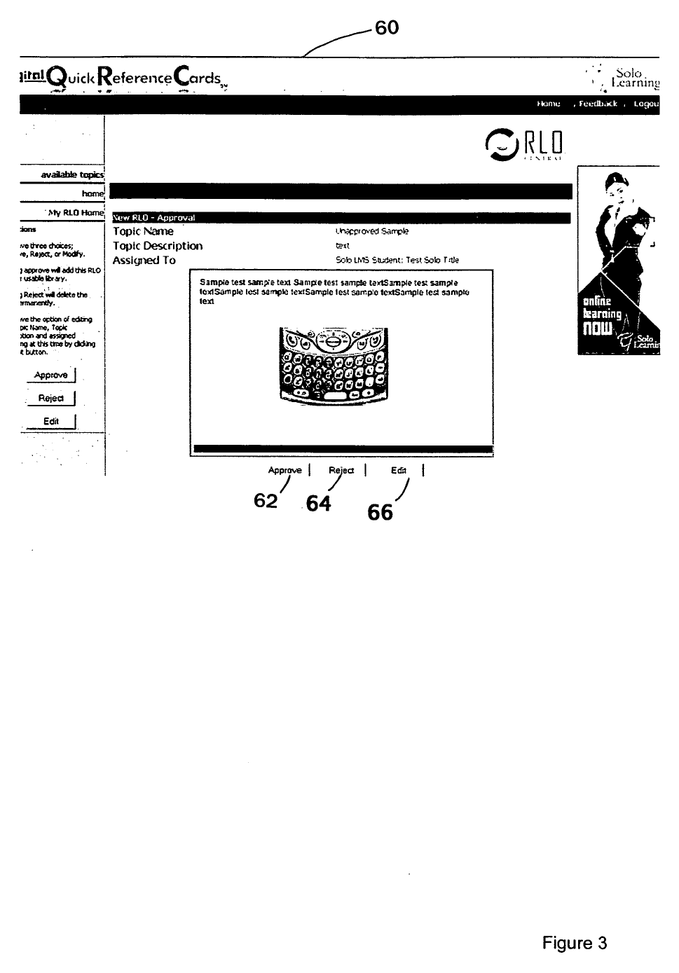

Selecting the APPROVE button 24 on FIG. 1 allows mangers to approve or reject newly created learning objects; accordingly, only managers given approval permission have access to this page. As can be seen by the screen 60 display in FIG. 3 the manager has the option of viewing the learning object and approving 62, rejecting 64 or editing 66 it. If the learning object is approved the content of the learning object is added to the suggested Title. If the content of the learning object is rejected the manager may remove reference to the learning object from the pending list and optionally send a rejection notice to the creator of the learning object with a reason for the rejection. Alternatively the manager may modify the learning object name or description of the learning object.

If the ADD TITLE button 26 is selected in FIG. 1 additional Titles may be included to which custom Topics may be added. Those of ordinary skill in the art will understand that there may be multiple sets of learning objects related to any particular Topic depending how the writer determines that the material is best presented to a user.

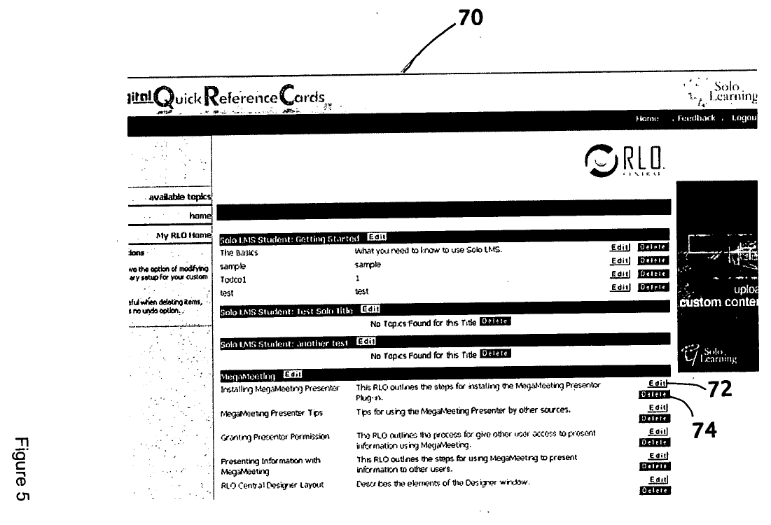

If the MANAGE button 28 is selected in FIG. 1 managers may edit and delete existing learning object information as shown by the screen 70 displayed in FIG. 5. The Edit button 72 allows the manager to edit the Title name and description. The Delete button 74 allows the manager to remove the Topic reference from the data base of learning object content.

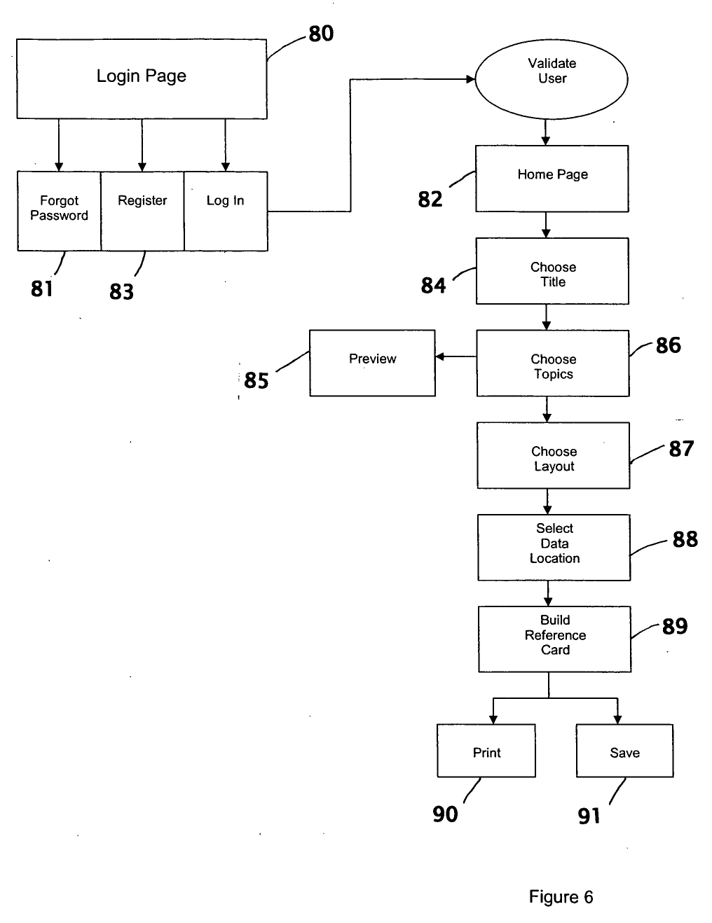

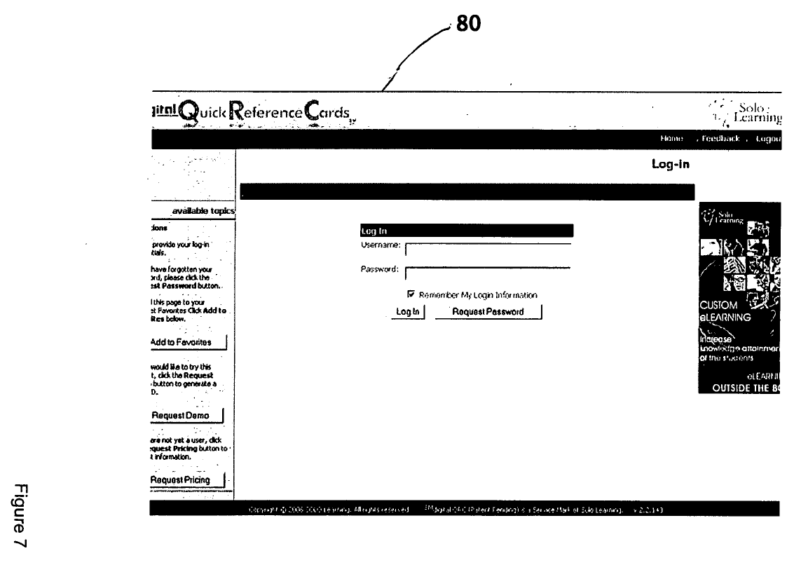

An overview of the user's operation of the system and method of the present invention is shown in FIG. 6. Specifically, a user approaches a computer terminal and is presented with a log-in page 80 such as shown in FIG. 7. If the user is a registered user the present invention will guide the user through the process of preparing a reference card. If the user is a registered user but has forgotten the password to get into the system of the present invention, the user is directed to another screen 81 requesting other authenticating information to enable access to the disclosed system and method.

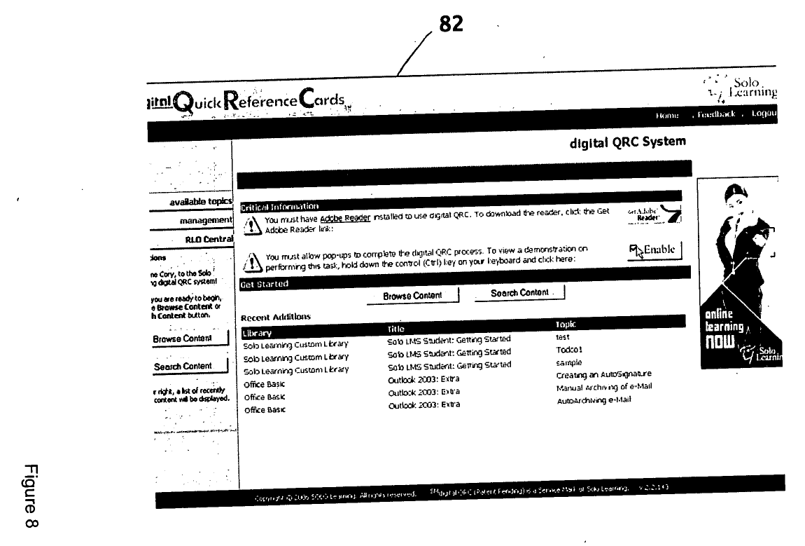

Once access to the present invention has been granted, the user gains access to the home page 82 as displayed on the screen shown in FIG. 8.

If the user is not a registered user, the user is directed to a series of screens 83 similar to those of other software systems for receiving a quote for use and payment for access to the disclosed system. Once the payment information has been accepted, account information is provided to the user for entry of a user name and password to gain access to the system. Once the user name and password have been recorded, future access to the system is through the use of the user name and password as described above.

The home page 82 displays a list of any new pre-written learning objective content that has been made available for users and any announcements to users by the administrators of the system.

From the home page 82 a user can gain access to a list of available Libraries or available Titles 84. As previously indicated Titles are a sub-category of a Library. Specifically, a Library is the top grouping level for content. There are an unlimited number of potential Libraries that can be used with the disclosed system. A Title is the second grouping of content under a Library. There are no limits to the number of Titles that can be contained within a Library. A Title is selected for use by placing a check in a box located next to the Title.

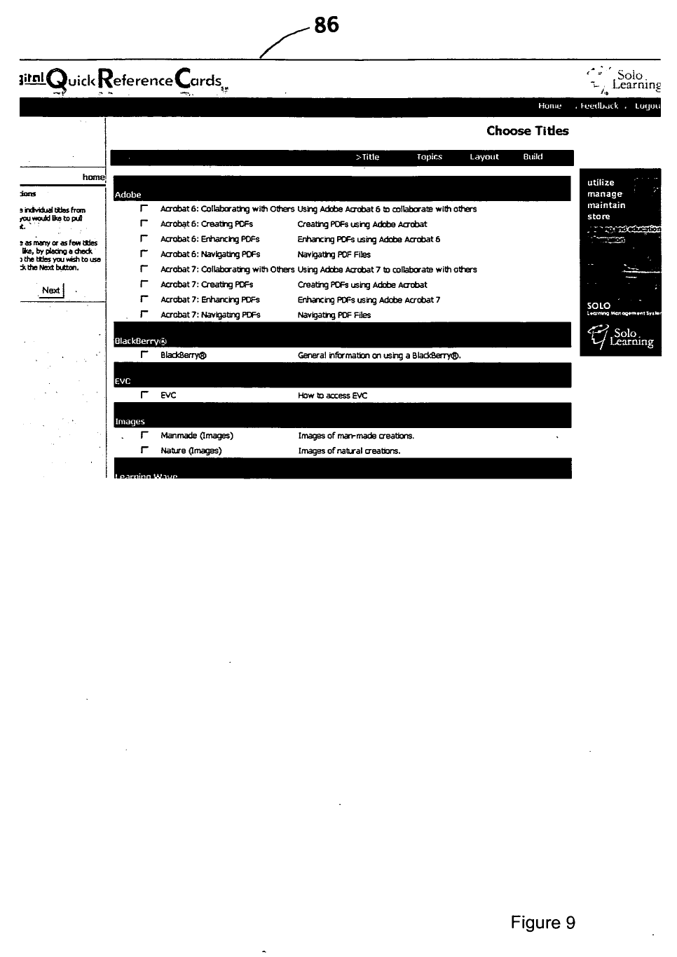

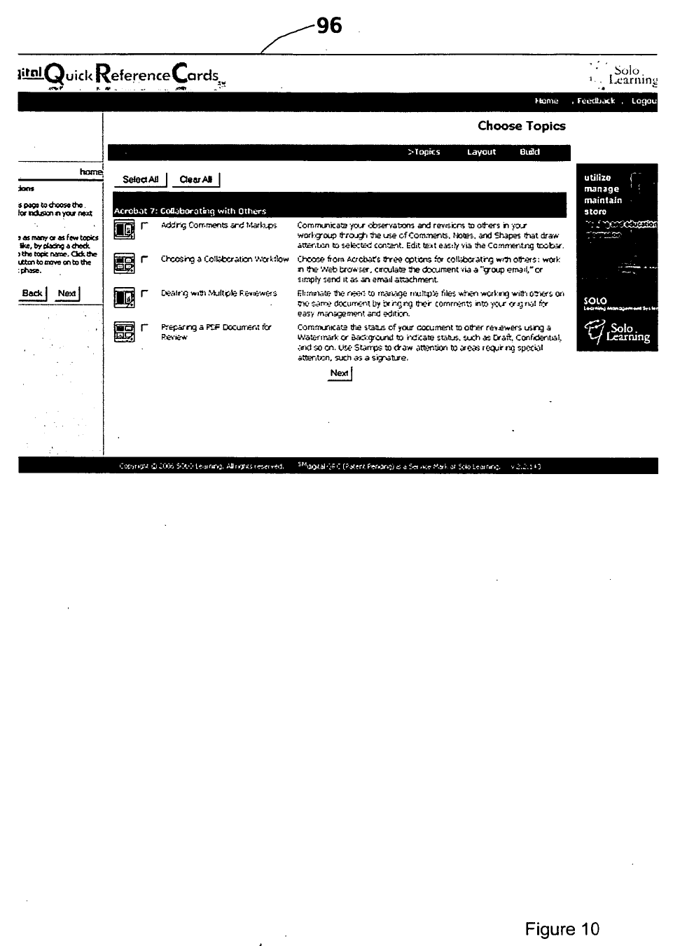

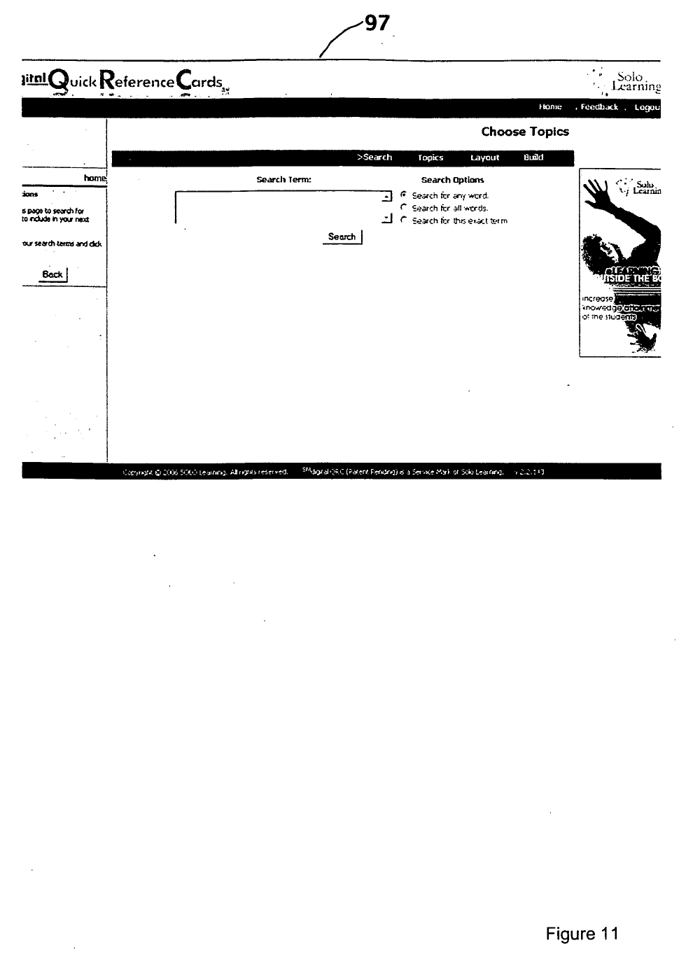

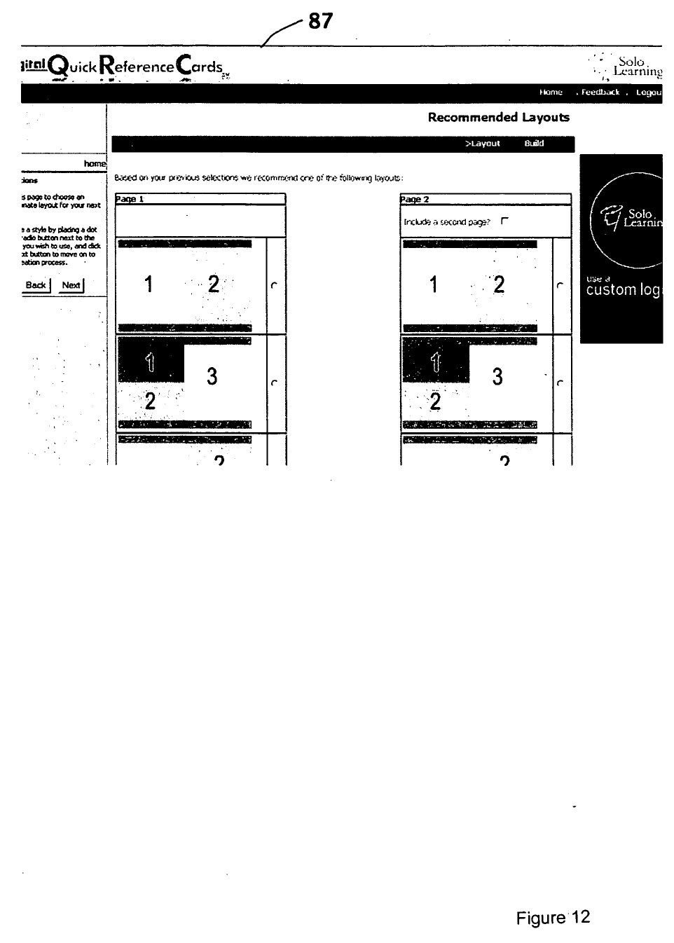

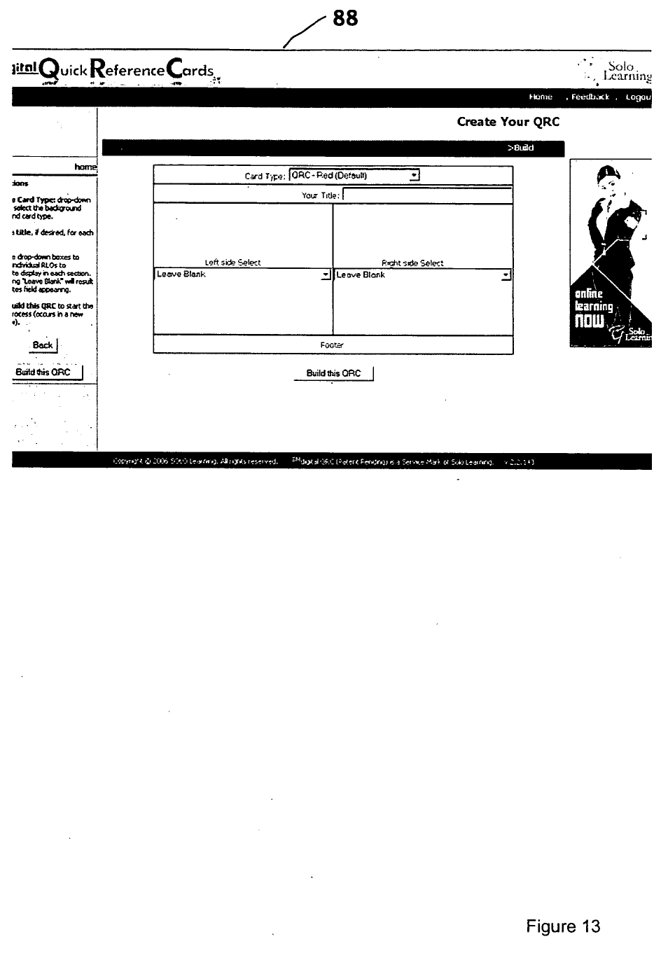

Selection of a Title leads to the selection of a Topic as shown on the screen 86 displayed in FIG. 9. Here the user is asked to select actual pre-written data items for inclusion in the reference card. Those of ordinary skill in the art will understand that there may be multiple pre-written data Items displaying the same content in a variety of different ways to appeal to a wide variety of users. Topics within a Title are displayed 96 for selection by the user as shown in FIG. 10. A preview screen 85 including an extract of a selected Topic may be used. Alternatively, the user may do a search for desired content by using the screen 97 displayed at FIG. 11. The selection of one or more Topics and clicking on the Next button takes the user to the next set of screens displayed in FIG. 12 and FIG. 13 for building a user-customized reference card.

Pre-written content has already proven especially useful when used to make reference cards that may be used with software applications. However, as previously indicated, the present invention is not limited to software applications. For example, products available at home improvement centers could be accompanied by user made reference cards to assist in a repair or installation project. Other applications, not related to a product such as time management or handling complaints, could also be the subject of a reference card.

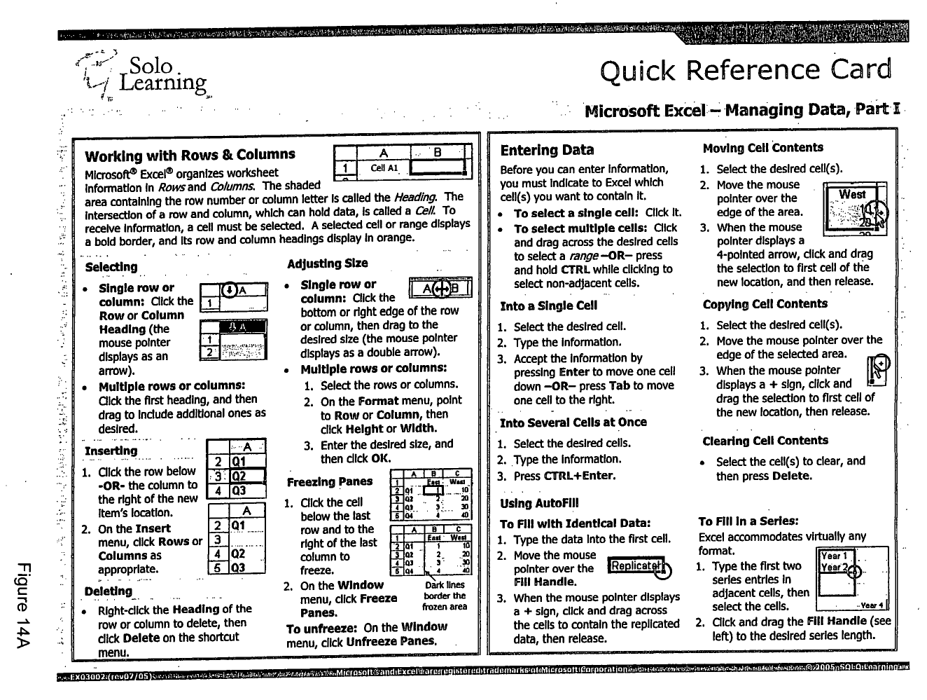

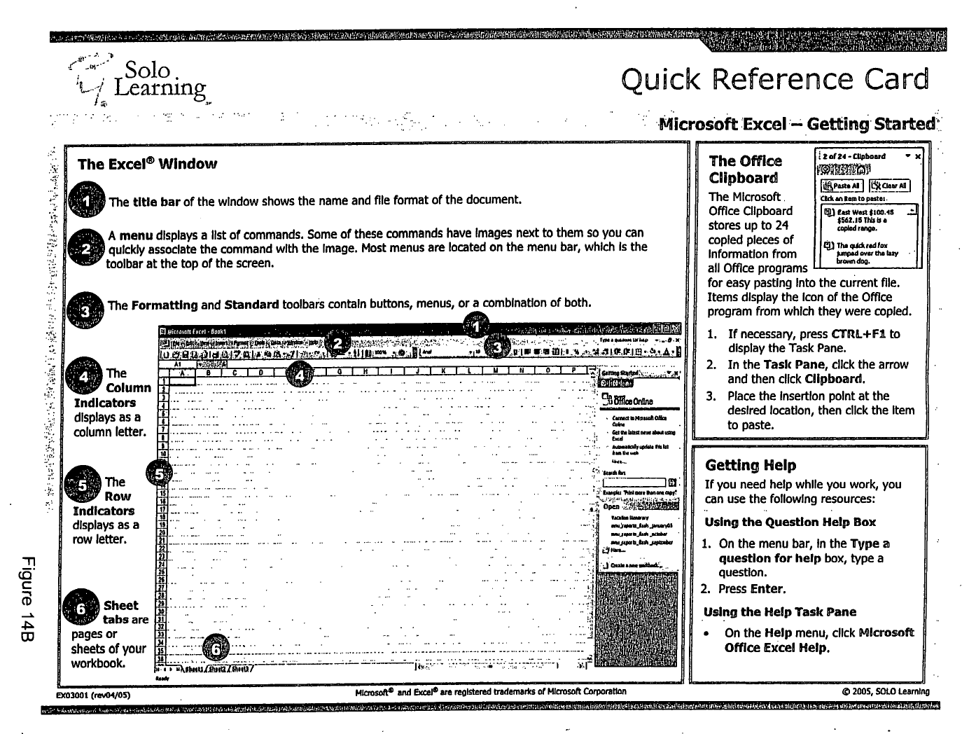

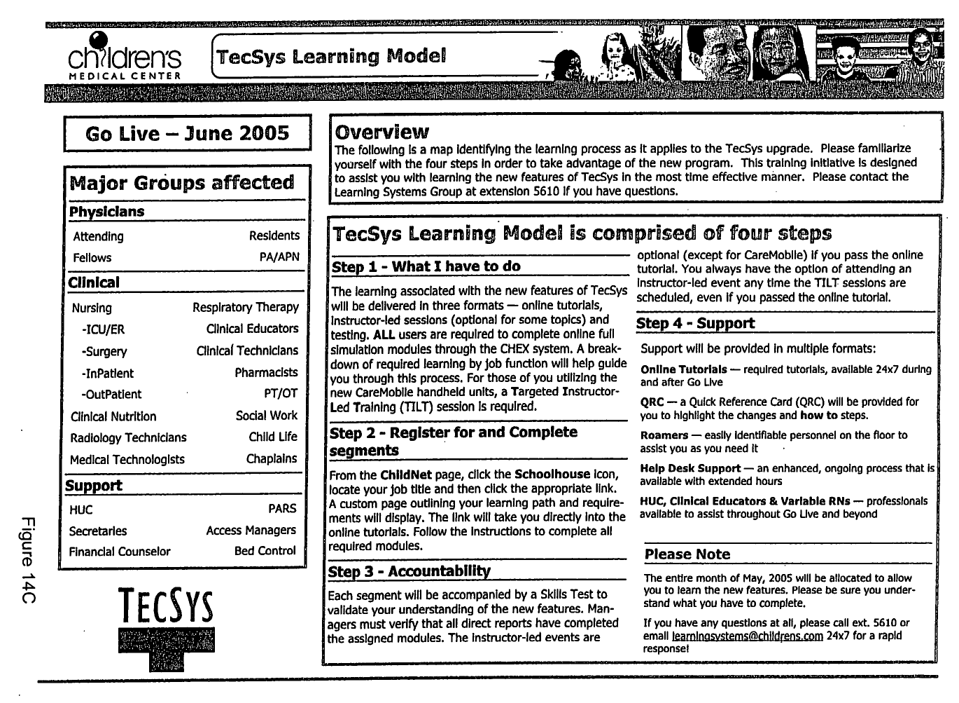

The selection of the way information is displayed has proven to be an intensely personal preference which has a significant impact of the utility of the information contained on a reference card. Accordingly, the user is provided first with macro layout of the reference card; for example, a one page or a two page format. The first screen 87 appears in FIG. 12 wherein the user is asked to select a page layout format. Once the page layout format has been selected the user is given the option of selecting a side of the page as shown on the screen 88 displayed in FIG. 13. A sample reference card appears in FIG. 14A and FIG. 14B. Yet another type of sample reference card appears in FIG. 14C.

Once the user has specified a macro layout of the reference card, the user places the selected pre-written content or the created content within the available spaces. Following the placement of the content in available spaces a reference card generator formats the quick reference card with the content chosen by the user and places it in a PDF format 89. The constructed reference cards, now in a PDF format can be saved to computer memory or a disk 90 for later deployment to a professional printer or to another for future use. Alternatively, the reference card in a PDF format may be sent to a printer 91 for immediate use.

While the reference cards shown in FIG. 14A, FIG. 14B and FIG. 14C are sized for printing on standard sized paper, the reference cards can be made pocket sized or put together as a series of either foldable cards or a small pamphlet for use by those who wear a lab coat such as medical personnel. Further the reference cards can be used for a video presentation if use of a hand held reference card is inconvenient such as in situations where the accomplishment of a task takes two hands or the reference card is to be used by handicapped users who may not have use of one or both hands. In still other situations, the content of the reference card can be placed in audio format for when a user's vision is directed to something else such as a patient in an emergency room.

In situations where the disclosed system is part of a training program within an organization, information can be provided to training administrators as to which users are using the disclosed system and method, what content has been downloaded and how frequently the system is being used.

Those involved in training will quickly see the advantages that are provided by the disclosed system and method over conventional system and methods of training. Most every person that has been asked to learn a new piece of software or to master a new skill begins by the inefficient process of going to a classroom where an instructor gives a presentation explaining the subject matter. The more skills that people must learn necessitates more and more time with an instructor in a classroom.

The ability to impart information is directly dependent on the teaching effectiveness of the instructor. As previously indicated, keeping a group of students interested and not losing the attention of the slower learners in the class, drives most instructors to direct their teaching toward the slower learners. Those who learn much faster often become bored when an instructor repeats instruction for the slower learners. The net result is that substantial resources are spent on the training of basic and possibly intermediate skills to slower learners when the training that provides the greatest return for a business is on mastering the advanced skills which set a business apart from its competitors.

By use of the system and method of the present invention, resources may be expended on increasing expertise in the most sophisticated and complex skills.

While the system and method of the disclosed invention has been explained according to its preferred embodiment, those of ordinary skill in the art will understand that numerous other embodiments have been enabled by the foregoing disclosure. Such other embodiments shall be included within the scope and meaning of the appended claims.

What is claimed is:

1. A method for building a set of reference cards for enhancing the ability of a reference card to users to perform predetermined tasks, said method comprising the steps of:
creating a set of learning objects;
placing said learning objects into a formatted layout;
identifying the needs of users of said learning objects with a survey tool;
matching the results of said survey tool to said set of learning objects;
selecting the learning objects needed to enhance the abilities of the users to perform predetermined tasks related to said identified needs;
identifying said selected learning objects; creating reference cards based on said selected learning objects in a format acceptable to a user.

2. The method of claim 1 wherein said learning objects relate to the operation of a piece of software.

3. The method of claim 1 wherein said learning objects relate to the performance of a multi-step procedure.

4. The method of claim 1 wherein said learning objects relate to the installation of a product.

5. The method of claim 1 wherein said learning objects relate to the operation of a product.

6. The method claim 1 wherein said learning objects relate to professional development.

7. The method of claim 1 further including the step of submitting said learning objects for approval before adoption.

8. The method of claim 1 wherein the layout of said reference cards may be customized by the user.

9. The method of claim 1 wherein said learning objects are selected from a pre-written set of learning objects.

10. The method of claim 1 wherein said reference cards may be reproduced in a format selected from a group including hard copy, video, and audio.

11. A system for building a set of reference cards for enhancing the ability of reference card to users to perform predetermined tasks, said system comprising:
a set of learning objects;
said learning objects being displayed into a formatted layout;
a survey tool identify the needs of users of said learning objects;
a match of the results of said survey tool to said set of learning objects;
a selection of the learning objects needed to enhance the abilities of the users to perform predetermined tasks related to said identified needs;
an identification of said selected learning objects;
reference cards based on said selected learning objects and created in a format acceptable to a user.

12. The system of claim 11 wherein said learning objects relate to the operation of a piece of software.

13. The system of claim 11 wherein said learning objects relate to the performance of a multi-step procedure.

14. The system of claim 11 wherein said learning objects relate to the installation of a product.

15. The system of claim 11 wherein said learning objects relate to the operation of a product.

16. The system claim 11 wherein said learning objects relate to professional development.

17. The system of claim 11 further including the step of submitting said learning objects for approval before adoption.

18. The system of claim 11 wherein the layout of said reference cards may be customized by the user.

19. The system of claim 11 wherein said learning objects are selected from a pre-written set of learning objects.

20. The system of claim 11 wherein said reference cards may be reproduced in a format selected from a group including hard copy, video, and audio.

21. A learning system including reference cards as memory refreshers, said learning system comprising:
a set of learning objects contained in a content database;
a survey tool for identifying the learning needs of the users of the learning system;
a map which matches the learning needs of the users to the content database;
a selector tool for removing needed learning objects from the content data database;
a style format tool for creating a reference card suitable to a user

22. The learning system as defined in claim 21 wherein said set of learning objects further comprises a set of pre-written learning objects.

23. The learning system as defined in claim 22 wherein said set of pre-written learning objects are crafted in a variety of different formats based on the learning styles of users.

24. The learning system as defined in claim 21 wherein said set of learning objects further comprise a set of learning objects prepared by a user.

25. The learning system as defined in claim 24 wherein said set of learning objects must be approved before being placed in said content database.
